(19) United States
(12) Patent Application Publication
(10) Pub. No.: US 2023/0105962 A1
(43) Pub. Date: Apr. 6, 2023

(54) Lithium-Ion Battery Having Extended Service Life

(71) Applicant: Bayerische Motoren Werke Aktiengesellschaft, Muenchen (DE)

(72) Inventors: Franz FUCHS, Muenchen (DE); Kevin GALLAGHER, Naperville, IL (US); Frederik MORGENSTERN, Mountain View, CA (US); Seokyoon YOO, Baldham (DE)

(21) Appl. No.: 17/785,732

(22) PCT Filed: Nov. 9, 2020
(86) PCT No.: PCT/EP2020/081469

§ 371 Date: Jun. 15, 2022

(30) Foreign Application Priority Data
Dec. 16, 2019 (DE) 10 2019 134 427.1

(51) Int. Cl. H01M 50/655; H01M 50/102; H01M 10/0525; H01M 50/30; H01M 50/184

(52) U.S. Cl. CPC H01M 50/655; H01M 50/102; H01M 10/0525; H01M 50/30; H01M 50/184; H01M 2300/0025

(57) ABSTRACT

A method for operating a battery with a hermetically sealed housing configured as a hardcase and containing at least one electrochemical cell based on an organic electrolyte is described. The method includes: opening the housing at a point configured to create a point of access to a housing interior so as to vent the at least one cell; and, after the opening, hermetically re-sealing the point of access to the housing interior. A battery which can be operated by this method is also described.

### BACKGROUND AND SUMMARY

The present disclosure relates to a method for operating a battery having a housing which is sealed hermetically, is embodied as a hardcase and contains at least one electrochemical cell based on an organic electrolyte. The present disclosure also relates to a battery which can be operated in accordance with this method.

FIGS. 1a to 1c show method steps for the production of a battery for storing electrical energy on an electrochemical basis, the battery containing at least one electrochemical lithium-ion cell based on an organic electrolyte. In a first method step, the unclosed battery 100 shown schematically in FIG. 1a is provided. This battery has a housing 101 which is embodied as a hardcase and is provided on one of its walls 104 with two connection terminals having different polarities (102, 103) and with an access to the housing interior. The electrodes, current collectors and conductors of the electrochemical cell are contained in the housing 101, and the conductors are each connected electrically to one of the two connection terminals 102 and 103. The access to the housing interior is embodied as an opening 105 in the housing wall 104 and is delimited/bordered by the part of the wall 104 that is labeled with the reference symbol 106. The part of the wall 104 that is contained within the dashed circle is represented schematically in FIG. 1b. This shows that the opening 105 at the housing-outside end has an opening section whose opening cross section is greater than the opening cross section of the remaining part of the opening. The arrow shown in FIG. 1b indicates a second method step, this being the introduction of organic electrolyte through the access to the housing interior 105, so as to fill up the cell (which is not shown in the figures) with organic electrolyte. Subsequently, in a third method step, the access to the housing interior 105 is sealed hermetically with a closure 113 consisting of metal. In this case the closure 113, which has substantially the shape of the opening section situated on the housing-outside end of the opening 105, is inserted into this section and welded to the housing wall 104, so that the opening 105′ now closed with the closure 113 is permanently hermetically sealed. The housing of the battery produced by this method cannot be opened again without chemical contamination of the organic electrolyte in the cell located therein. The third method step is represented schematically in FIG. 1c.

The lifetime of a battery produced in this way is governed substantially by aging processes which take place in the lithium-ion cell. These processes lead firstly to consumption of organic electrolyte and cyclable lithium, and secondly to the evolution of gases which cause the gas pressure in the cell to grow. The rise in the gas pressure in the cell in particular is associated with a reduction in the contacts between the electrodes. The gas pressure at and beyond which the contacts between the electrodes start to reduce may be dependent, moreover, on the following factors: the mechanical properties of the cell housing; the arrangement of the electrodes, embodied as a jelly roll or as a stack, in the cell housing; and the design of the cell housing. For example, in a standard PHEV2 prismatic hardcase, accelerated aging of the lithium-ion cell may begin at and beyond an internal gas pressure of around 3 bar.

In a battery produced according to the method described hitherto, the internal gas pressure rises continually and, when a certain internal gas pressure has been reached, the cell begins to undergo accelerated aging.

It is therefore an object of the present disclosure to provide a battery which comprises a housing, sealed hermetically and embodied as a hardcase, and an electrochemical lithium-ion cell based on an organic electrolyte, and with which accelerated aging of the cell due to the evolution of gases can be prevented or at least attenuated.

The achievement of this object may be attained in accordance with the teaching of the independent claim(s). Various embodiments and developments of this teaching are subjects of the dependent claims.

It is, further, an object of the present disclosure to specify a method which, applied to the battery, prevents or at least attenuates accelerated aging of the cell due to the evolution of gases.

The achievement of this object may be attained in accordance with the teaching of the independent claim(s). Various embodiments and developments of this teaching are subjects of the dependent claims.

A first aspect of relates to a battery for storing electrical energy on an electrochemical basis, comprising: a housing sealed hermetically and embodied as a hardcase; and at least one electrochemical cell based on an organic electrolyte and contained in the housing; wherein a point in the wall of the housing is provided for the creation of an access to the housing interior, wherein the point for the creation of the access to the housing interior is designed to create the access to the housing interior and to hermetically close again the access created to the housing interior; and wherein the access to the housing interior is designed in the opened state to vent the electrochemical cell.

As a result, the method can be applied to the battery. Following application thereof, a battery is provided which has an internal gas pressure reduced to standard pressure (atmospheric pressure at the Earth's surface), and this substantially extends the lifetime of the battery.

The one or more electrochemical cells contained in the housing are preferably lithium-ion cells.

In one preferred embodiment the access to the housing interior is further designed in the opened state for the filling of the electrochemical cell with additional electrolyte.

As a result, following application of the method, the electrolyte can be at least partly renewed and hence the lifetime of the battery can additionally be increased.

In one preferred embodiment, the point for the creation of an access to the housing interior is embodied as an opening in the wall of the housing that is sealed hermetically with a closure, and is further designed to create the access to the housing interior by puncturing of this closure.

As a result, the access can be created to the housing interior in a simple way, quickly and reliably.

In one preferred embodiment, the opening cross section of the opening sealed hermetically with the closure widens continuously or incrementally from the housing interior outward; wherein the opening comprises at least two opening sections having different-sized opening cross sections; and wherein the closure is recessed relative to the housing-outside end of the opening.

After application of the method, a further closure can be installed with recessing relative to the outer face of the wall (and hence protected against external mechanical exposure), and the opening can be hermetically closed reliably and efficiently.

Where the opening has more than two opening sections with different-sized opening cross sections, the method may then be applied advantageously at least twice (or a greater number of times) to one and the same battery.

For the purposes of the present disclosure, an opening cross section of an opening section means a cross section of the opening section that is (substantially) perpendicular to the depth direction of the opening. The opening cross sections of an opening section may have the same size and shape. This is the case, for example, when the opening section has a cylindrical form.

In one preferred embodiment, the limit of the opening formed in the wall of the housing is staircase-shaped or conical.

As a result, the shape of the closure can be kept simple, in the form, for example, of a cylindrical or frustoconical disk.

In one preferred embodiment, the closure is disposed in an opening section of the opening whose shape substantially matches the shape of the external edge of the closure, and where the external edge of the closure is joined hermetically to the housing wall surrounding it.

As a result, the closing of the access/opening can be carried out particularly efficiently and reliably.

The thickness of the closure has dimensions, for example, such that it can be punctured with the tip of a puncturing tool. It is advantageous if the surface of the tip is smooth, so that puncturing does not give rise to any particles which can enter the interior of the housing and cause unwanted short-circuiting of an electrochemical cell located therein. With preference both the closure and the housing are embodied of metal, and the closure is soldered or welded to the wall of the housing. The metal may be aluminum.

The opening cross sections of the opening or of individual opening sections may be one of the following or a combination thereof: circular, oval, rectangular, polygonal. The opening may also comprise opening sections each having different-shaped opening cross sections. For example the opening may have a round opening section and a rectangular opening section disposed above the round opening section.

In one preferred embodiment the closure is embodied as one of the following:
a planar disk or plate;
a planar disk or plate whose surface side facing the housing interior is covered with a polymer layer;
a disk or plate which, at least on one surface side of the closure, in an internal region, comprises an indentation;
a disk or plate which, at least on one surface side of the closure, in an internal region, comprises an indentation, and the indentation facing the housing interior is covered with a polymer layer.

As a result, depending on energy input during the welding or soldering of the closure to the housing wall, the appropriate closure can be selected. For example, in the case of a relatively high energy input, which could possibly cause damage to a thin, planar closure, a closure can be selected which comprises at least one indentation. This closure is made thin only in an internal region, and this internal region is surrounded entirely by an external edge region which is made thick. The thickness of the external edge region here is configured such that the closure cannot be damaged by the energy input which accompanies the welding or soldering. It is also possible to select a closure which prevents particles from entering the housing interior when the closure means is punctured, where they can trigger a short-circuit. For this purpose it is possible, for example, to select a closure which comprises a polymer layer on the surface side facing the housing interior.

The closure is preferably embodied of aluminum.

In one preferred embodiment, the point for the creation of an access to the housing interior is embodied as a screw closure, and this closure is designed to create an access to the housing interior by unscrewing of the screw cap and to close again an access created to the housing interior by screwing of the screw cap.

As a result, the access to the housing interior can be opened and reclosed as often as required; and accordingly the method of the invention can be applied as often as required to one and the same battery.

A second aspect of the invention relates to a method for operating a battery having a housing which is sealed hermetically and embodied as a hardcase and in which at least one electrochemical cell based on an organic electrolyte is contained, comprising: opening the housing at a point thereon configured for that purpose for the creation of an access to the housing interior, so as thereby to vent the at least one cell; and hermetically reclosing the access to the housing interior resulting from the opening of the housing.

As a result, the battery can be vented, meaning that its internal gas pressure can be reduced to standard pressure (atmospheric pressure at the Earth's surface) and the penetration of water into the housing interior prevented.

The one or more electrochemical cells contained in the housing are preferably lithium-ion cells.

In one preferred embodiment the method further comprises: introducing additional electrolyte through the access to the housing interior resulting from the opening of the housing, so as to fill up the cell with the additional electrolyte.

As a result, spent organic electrolyte can be replaced, thereby additionally increasing the lifetime of the battery. Organic electrolyte may become spent during the operation of the battery as a result of chemical secondary reactions in the cell, and the resultant reaction products may accumulate over the course of time.

In one preferred embodiment, the housing is opened at the point configured for that purpose by means of puncturing of a first closure previously closing the access.

As a result, the access to the housing interior can be created in a simple way, rapidly and reliably.

The first closure may be punctured with the tip of a puncturing tool. The thickness of the first closure here is dimensioned such that the first closure can be punctured with the puncturing tool; and both the first closure and the puncturing tool are configured such that the puncturing does not produce any particles which can enter the housing interior and cause unwanted short-circuiting of an electrochemical cell located therein. In this sense it is advantageous if the first closure is made of aluminum and the surface of the tip is smooth.

In one preferred embodiment, the point for the creation of an access to the housing interior is embodied before being opened as a hermetically sealed opening in the wall of the housing, the cross section of this opening widening continuously or incrementally from the housing interior outward; where the opening before being opened is sealed hermetically by the first closure; where the first closure is recessed relative to the housing-outside end of the access; and where the access is hermetically reclosed by placement of a second closure into the opening, above the recessed first closure.

As a result, the second closure can not only be recessed relative to the outer face of the wall (and hence protected against external mechanical exposure), but the access created to the housing interior can also be hermetically sealed reliably and efficiently.

Preferably, the opening has at least two opening sections having different-sized opening cross sections; the first closure is recessed in the opening section having the smaller opening cross section, relative to the opening section having the larger opening cross section; and the second closure is installed in the opening section having the larger opening cross section. In this case the shape of the external edge of the second closure may match the shape of the wall section which is in contact with the second closure.

In one preferred embodiment, the second closure is disposed into an opening section of the opening whose shape substantially matches the shape of the external edge of the second closure, and the external edge of the second closure is joined hermetically to the housing wall surrounding it.

As a result, the hermetic reclosing of the access, more particularly by welding of the edge of the second closure to the wall section surrounding it, can be carried out particularly efficiently and reliably.

The opening cross section of the opening section in which the second closure is disposed may be one of the following or a combination thereof: circular, oval, rectangular, polygonal.

The second closure may also be installed on the outer face of the housing such that it covers the entire opening, and may be joined hermetically to the outer face of the housing. In this case the shape of the external edge of the second closure can be selected independently of the opening cross sections of the opening.

The housing and the second closure are preferably made of metal (e.g., aluminum), and the second closure is joined hermetically to the housing wall surrounding it, by welding/soldering.

To reopen the housing, reclosed with the second closure, by puncturing of the second closure means, it is advantageous: to dimension the thickness of the second closure such that it can be punctured with the puncturing tool; and to configure both the second closure and the puncturing tool such that puncturing does not produce any particles which can enter the housing interior and cause unwanted short-circuiting of an electrochemical cell located therein. It is especially advantageous if the second closure is made of aluminum.

In one preferred embodiment, the puncturing takes place using a puncturing tool which has a tubular part, and the additional electrolyte is introduced using the tubular part of the puncturing tool.

As a result, the filling of the additional organic electrolyte can be achieved in a simple way, efficiently and reliably.

In one preferred embodiment, the point for the creation of an access to the housing interior is embodied as a screw closure, where the housing is opened by opening of the screw closure, and the housing is hermetically closed by the closing of the screw closure.

As a result, the access to the housing interior and also the reclosing of that interior can not only be achieved in a simple way but can also be carried out as often as required; and therefore the method can in principle be applied as often as required to one and the same battery.

In one preferred embodiment, the additional electrolyte is of the same type as the electrolyte contained in the cell; or the additional electrolyte comprises one or more additives whose effect is to extend the lifetime of the cell and/or which attenuate or inhibit secondary reactions of the electrolyte with the electrodes of the cell; or the additional electrolyte comprises lithium-containing molecules, more particularly lithium-containing salts, which, in a cell cycle following the introduction of the additional electrolyte, provide additional electrochemically active lithium.

As a result, the lifetime of the battery can be additionally extended.

The present invention also pertains to a battery which can be operated according to this method.

### BRIEF DESCRIPTION OF THE DRAWINGS

Further advantages, features and possible applications of the present invention are apparent from the detailed description below in association with the figures.

Each of FIGS. 1a to 1c shows schematically a step of a known method for producing a battery.

Each of FIGS. 2a to 2c shows schematically a step of a method for producing a battery of the invention.

FIG. 2d shows a battery of the invention according to a first embodiment.

Each of FIGS. 2e and 2f shows schematically a step of a method of the invention for operating the battery according to a first embodiment.

FIGS. 2g and 2h show schematically a section in vertical direction of two variants of the first closure.

FIG. 2i shows schematically the hermetic closing of the battery housing with one variant of the first closure.

FIG. 2j shows schematically the hermetic closing of the battery housing with another variant of the first closure.

FIG. 3a shows schematically a battery of the invention according to a second embodiment.

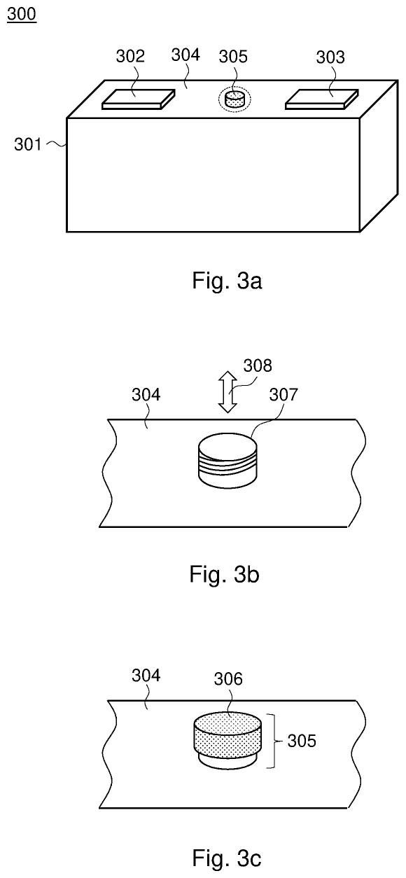

Each of FIGS. 3b and 3c shows schematically a step of a method of the invention for operating the battery according to the second embodiment.

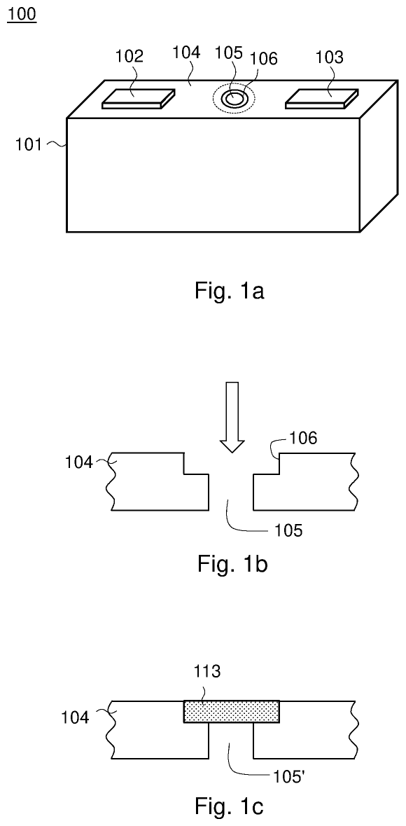

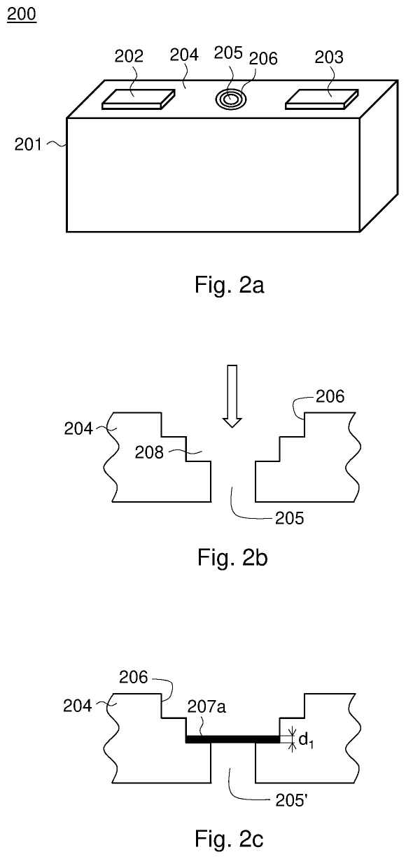

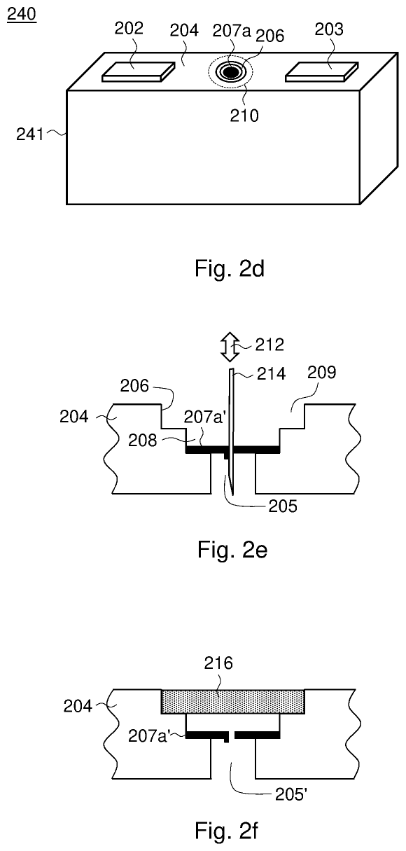

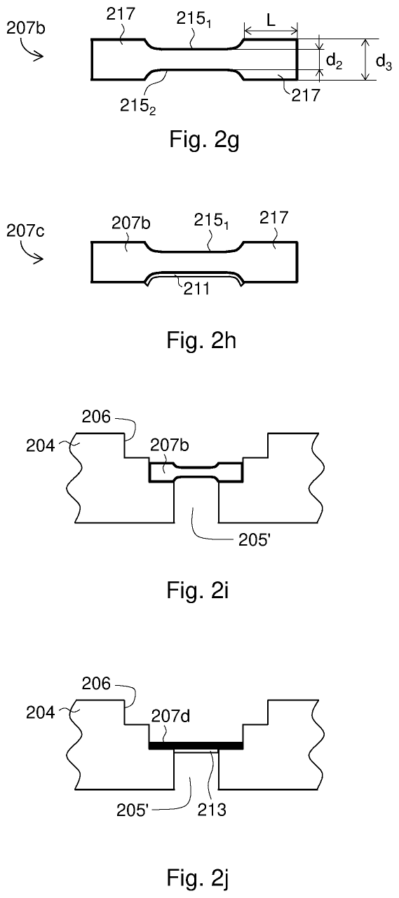

FIGS. 2a to 2c show schematically a method for producing a battery of the invention for storing electrical energy on an electrochemical basis, which comprises at least one electrochemical lithium-ion cell based on an organic electrolyte.

### DETAILED DESCRIPTION

In a first method step an unclosed battery 200 is provided. This battery is represented schematically in FIG. 2a and comprises: a housing 201 which is embodied as a hardcase and is provided on one of its walls 204 with two connection terminals having different polarities, 202 and 203, and with an access to the housing interior; and the electrodes, current collectors and conductors of at least one electrochemical cell which are contained in the housing 201 (and therefore are not represented schematically in the figures). Each of the two connection terminals 202 and 203 is electrically connected to a conductor corresponding to their respective polarity. The housing 201 may contain the electrodes, current collectors and conductors of a plurality of cells.

The access to the housing interior is embodied as an opening 205 in the housing wall 204 and is delimited/bordered by the part of the wall 204 that is labeled with the reference symbol 206. FIG. 2b shows schematically a longitudinal section of the opening 205. Longitudinal section of the opening here refers to the representation of the sectional face as would be formed in the case of a section made in depth direction through the opening 205. As is readily apparent from FIG. 2b, the opening 205 comprises a plurality of opening sections having different-sized opening cross sections, which outwardly widen incrementally; and the part of the housing wall 204 that surrounds/borders the opening 205 has a staircase-shaped embodiment. It is, however, also possible for the opening sections to outwardly widen continuously, and for the part of the housing wall surrounding them to have a conical embodiment. The shape of the opening cross sections may be circular, oval, rectangular, or polygonal.

The electrolyte required for operation of the electrochemical cell or cells is introduced into the housing 201 via the access to the housing interior, which is embodied as an opening 205. This introduction of the electrolyte into the housing takes place in a second method step and is indicated schematically with an arrow in FIG. 2b.

After the introduction of the electrolyte into the housing 201, the housing 201 is sealed hermetically in a third method step, to prevent the penetration of water into the housing interior. As shown in FIG. 2c, this is accomplished by hermetic closing of the opening with a first closure 207a . The first closure 207a may be embodied as a disk or plate and may have a shape which corresponds (with substantial matching) the opening cross section of the opening section 208. The opening is closed hermetically by placing the first closure 207a into the opening section 208 and joining it hermetically, by welding or soldering, to the part of the housing wall that (substantially) surrounds, with contact, the external side edge of the first closure 207a. The hermetically sealed opening 205′ thus realized prevents the penetration of water into the housing interior. The first closure 207a is configured such that it can be punctured with a puncturing tool to again create an access to the housing interior. Advantageously, the first closure 207a is made of aluminum, is planar, and has a thickness di which may be in a range from 0.2 mm and 0.4 mm.

FIG. 2d shows a battery 240 according to a first embodiment of the present invention, which can be produced according to the method described in connection with FIGS. 2a to 2c. The battery 240 for storing electrical energy on an electrochemical basis comprises: a housing 241 which is sealed hermetically and embodied as a hardcase, and one or more electrochemical cells based on an organic electrolyte, which are contained in the housing 241 and are connected to two connection terminals having different polarities, 202 and 203, which are disposed on the housing 241. Further, in the wall 204 of the housing, a point 210 is provided for creating an access to the housing interior, and is designed to create an access to the housing interior and to close again hermetically an access to the housing interior that has been created. Furthermore, in the opened state, the access to the housing interior is designed to vent the one or more electrochemical cells and/or to fill up the one or more electrochemical cells with additional electrolyte.

According to the first embodiment, the point 210 for the creation of an access to the housing interior is embodied as an opening 205′, sealed hermetically with a first closure 207a, in the wall 204 of the housing 241, and is further designed/configured to create the access to the housing interior by puncturing of this first closure 207a. A longitudinal section of the point 210 is represented schematically in FIG. 2c.

More particularly, the first closure 207a is configured such that it can be punctured with the tip of a puncturing tool; the tip of the puncturing tool is embodied such that the puncturing of the first closure 207a does not produce any particles which can enter the housing interior and cause unwanted short-circuiting of an electrochemical cell located therein. As shown in FIG. 2c, the first closure 207a may be embodied as a disk or plate, having a thickness d₁. Advantageously the first closure 207a is made of aluminum, is planar, and has a thickness d₁ which may be in a range between 0.2 mm and 0.4 mm.

As is readily apparent from FIG. 2c, the opening cross section of the opening 205′ sealed hermetically with the closure 207a outwardly widens incrementally from the housing interior, and the part of the housing wall delimiting the opening 205′ has a staircase-shaped embodiment. Further, the opening 205′ has two opening sections with different-sized opening cross sections, and the closure 207a is recessed in the middle opening section 208 relative to the housing-outside end of the opening 205′. The shape of the (external) edge of the closure 207a also matches the shape of the opening section 208. The opening 205′ may have more than two opening sections with different-sized opening cross sections. It is also possible for the opening sections to outwardly widen continuously, and for the part of the housing wall surrounding them to have a conical embodiment. The shape of the opening cross sections may be circular, oval, rectangular, or polygonal.

FIGS. 2e and 2f show schematically a method of the invention for operating a battery according to the first embodiment. This method is applied to a battery according to the first embodiment, to extend the life of the battery, but more particularly to prevent or at least attenuate accelerated aging of the battery. The accelerated aging of the battery may begin when a certain gas pressure is attained in the housing interior of the battery. The aging of the battery may also be accelerated by the consumption of cyclable lithium.

In a first step of the method for operating a battery according to the first embodiment (240), the housing 241 is opened at the point 210 configured thereon for the creation of an access to the housing interior. FIG. 2e shows schematically a longitudinal section of this point 210 during the opening of the housing 241. The figure further indicates that the housing 241 is opened by puncturing of the first closure 207a with a puncturing tool 214. The puncturing tool 214 used in this case has a tip with a smooth surface, so that on the one hand the first closure 207a can be more easily puncturing, and on the other hand the puncturing does not produce any particles which can enter the housing interior and cause unwanted short-circuiting of an electrochemical cell located therein.

The puncturing tool 214 may be embodied as a tube or a tubular needle. In this case, as shown in FIG. 2e, the end of the tube or of the tubular needle 214 that is located outside the housing interior can be considered to be the access to the housing interior. Consequently the access to the housing interior 212 created by the puncturing of the closure 207a′ is symbolized by the double-ended arrow located at the top end of the tube 214.

The point 210 for the creation of an access to the housing interior is configured or disposed relative to the electrochemical cells located in the housing 241 in such a way that by means of the access 212 created by the puncturing of the closure 207a, the electrochemical cells can firstly be vented and secondly filled up with additional electrolyte.

The creation of the access to the housing interior 212 leads automatically to venting of the cells, and the cells can be filled with additional electrolyte in a further step, by introduction of additional electrolyte through the access 212 formed during the opening of the housing 241.

In a second step of the method for operating a battery according to the first embodiment (240), the access 212 formed by the opening of the housing 241 is hermetically reclosed. FIG. 2f shows schematically a longitudinal section of this access to the housing interior, reclosed hermetically. The figure further indicates that the hermetic reclosing of the access is accomplished by installation of a second closure 216 into the opening 205, above the punctured first closure 207a′. The external edge of the second closure 216 may have a shape which substantially corresponds to the shape of the opening section 209 located on the housing-outside end of the opening 205. A second closure 216 embodied in this way may, as shown in FIG. 2f, be inserted into the opening section 209 and joined hermetically to the housing wall 204 surrounding it. The joining of the second closure 216 to the housing wall 204 may be accomplished by welding or soldering.

As a result of the hermetic reclosing of the access, the opening 205′ (and hence the housing 241) is hermetically sealed again and the penetration of water into the housing interior is prevented.

The second closure 216 may be configured (similarly to the first closure 207a) in such a way that it can be punctured with the tip of a puncturing tool; the tip of the puncturing tool is embodied such that the puncturing of the second closure 216 does not produce any particles which can enter the housing interior and cause unwanted short-circuiting of an electrochemical cell located therein. The second closure 216 is advantageously configured like the first closure. In this case the method for operating a battery according to the first embodiment may also be applied a second time to one and the same battery, and the lifetime of the same battery may be extended further.

The second closure 216 may also be configured (similarly to the closure 113) in such a way that it cannot be punctured with a puncturing tool or can be punctured with a puncturing tool only to an extent such that the puncturing of the second closure 216 produces particles which can enter the housing interior. In this case the method for operating a battery according to the first embodiment cannot be applied a second time to that battery.

Further variants of a first closure are shown in FIGS. 2g to 2j. Each of these first closure may be used/employed in the method for producing a battery of the invention, in the context of the hermetic closing of the opening 205, instead of the first closure 207a. The batteries in which the opening 205 is sealed hermetically with one of the first closure shown in FIGS. 2g to 2j may also be operated according to the method of the invention.

FIG. 2g shows schematically a section in vertical direction of the first closure 207b. This closure, like the first closure 207a, may have a disk or plate embodiment and a shape which corresponds (substantially matches) the opening cross section of the opening section 208. However, at least one surface side of the closure 207b has an internal indentation 215₁ which is located at a minimum distance L from every point on its edge. This indentation is surrounded all round by the thicker edge region 217. Advantageously, both surface sides of the closure 207b each have an indentation, which are opposite one another and are surrounded all round by the thicker edge region 217. As a result of the indentation 215₁ or the two opposite indentations 215₁ and 215₂, the interior region of the closure 207b has at least in places a thickness d₂ which is less than the thickness d3 of the edge region 217.

Advantageously, the first closure 207b is made of aluminum, the thickness d₂ for a closure 207b embodied of aluminum is in a range between 0.05 mm and 0.3 mm, and the thickness d₃ for a closure embodied of aluminum is in a range between 0.2 mm and 0.8 mm.

FIG. 2h shows schematically a section in vertical direction of the first closure 207c. This differs from the closure 207b in that an indentation is covered with a polymer layer 211 or coated with a polymer. The polymer may for example be polypropylene or a polyethylene.

FIG. 2i shows schematically the closing of the battery housing 201 using the first closure 207b. This closure is inserted here into the opening section 208, and the part of the housing wall which (substantially) surrounds, with contact, the external side edge of the first closure 207b is joined hermetically to the edge region 217 by welding or soldering. Advantageously, the minimum distance L and hence the width of the edge region 217 are selected such that the contact area between the edge region 217 and the housing wall is at a maximum. As a result of the thicker implementation of the edge region 217 and/or of a large contact area between this region and the housing wall, it is possible to prevent the thinner internal region being damaged by the input of heat which takes place during the welding or soldering. On the other hand, the internal region of the closure 207b is more easily punctured if it is thinner.

The closing of the battery housing 201 using the first closure 207c takes place like the closing of the battery housing using the first closure 207b , but when the first closure 207c is used, it is inserted into the opening section 208 in such a way that the indentation with the polymer layer 211 is facing the housing interior. It is advantageous for the polymer layer 211 and the housing wall not to make contact with one another. The polymer 211 may prevent particles possibly formed during the puncturing of the closure 207c from entering the housing interior and triggering a short circuit in an electrochemical cell.

FIG. 2j shows schematically the closing of the battery housing 201 using the first closure 207d. This closure, like the closure 207a, is embodied as a planar disk or plate, but on the surface side facing the housing interior it has a polymer coating 213, which may for example comprise polypropylene or polyethylene. The closing of the battery housing 201 using the first closure 207d takes place like the closing of the battery housing using the first closure 207a, but when the first closure 207d is used, it is inserted into the opening section 208 in such a way that the surface side with the polymer layer 213 is facing the housing interior. It is advantageous if the polymer layer 213 and the housing wall do not come into contact with one another. The polymer layer 213 may prevent particles possibly formed during the puncturing of the closure 207d from entering the housing interior.

FIG. 3a shows a battery 300 for storing electrical energy on an electrochemical basis, according to a second embodiment of the present invention. The battery 300 comprises: a housing 301 sealed hermetically and embodied as a hardcase, and one or more electrochemical cells based on an organic electrolyte, which are contained in the housing 301 and are connected to two contact terminals having different polarities, 302 and 303, which are disposed on the housing 301. Further, in the wall 304 of the housing, there is a point 310 provided for the creation of an access to the housing interior, this point being designed to create an access to the housing interior 308 and to hermetically close again an access to the housing interior that has been created. Furthermore, in the opened state, the access to the housing interior 308 is designed to vent the one or more electrochemical cells and/or to top up the one or more electrochemical cells with additional electrolyte.

According to the second embodiment, the point 310 for the creation of an access to the housing interior is embodied as a screw closure 305, which is designed to create the access 308 to the housing interior by unscrewing of the screw cap 306, and to close again the access 308 to the housing interior that has been created, by screwing of the screw cap 306. The point 210 is further represented schematically in FIGS. 3b and 3c.

FIGS. 3b and 3c show schematically a method of the invention for operating a battery according to the second embodiment. This method is applied to a battery according to the second embodiment in order to extend the lifetime of the battery, but more particularly to prevent or at least attenuate accelerated aging of the battery.

In a first step of the method for operating a battery according to the second embodiment (300), the housing 301 is opened by opening of the screw closure 305. FIG. 3b indicates this step schematically.

Relative to the electrochemical cells located in the housing 301, the point 310 for the creation of an access to the housing interior is disposed or configured in such a way that the electrochemical cells can on the one hand be vented and on the other hand filled up with additional electrolyte by means of the opening of the screw closure 305.

The opening of the screw closure 305 leads automatically to venting of the cells, and the cells can be topped up with additional electrolyte in a further step, by introduction of additional electrolyte through the access made to the housing interior 308.

In a second step of the method for operating a battery according to the second embodiment (300), the access to the housing interior 308 is hermetically reclosed by closing of the screw closure 305. FIG. 3b indicates this step schematically. As a result of the closing of the screw closure 305, the housing 301 is hermetically sealed again and the penetration of water into the housing interior is prevented.

In both methods of the invention, the additional electrolyte topped up may be of the same type as the electrolyte contained in the cell; it may comprise one or more additives whose effect is to extend the lifetime of the cell and/or reduces or inhibits secondary reactions of the electrolyte with the electrodes of the cell; it may comprise lithium-containing molecules, more particularly lithium-containing salts, which in a cell charging cycle following the introduction of the additional electrolyte provide additional electrochemically active lithium.

Whereas in the text above at least one illustrative embodiment has been described, it should be noted that a large number of variations thereon exists. In this context it should also be borne in mind that the illustrative embodiments described constitute only non-limiting examples, and there is no intention thereby to restrict the scope, the applicability or the configuration of the methods and devices described here. Instead, the preceding description provides the skilled person with instructions for implementing at least one illustrative embodiment, it being understood that various alterations in the functioning and the arrangement of the elements described in an illustrative embodiment may be made without departing from the subject matter specified in each of the appended claims and also from the legal equivalents of said subject matter.

### LIST OF REFERENCE SYMBOLS

100 Unclosed battery
101 Battery housing
102, 103 Electrodes having different polarities
104 Wall of the housing
105, 105′ Unsealed and sealed opening, respectively
106 Limit/border of the opening

### 113 Closure

200 Unclosed battery
201 Battery housing
202, 203 Electrodes having different polarities
204 Wall of the housing
205, 205′ Unsealed and sealed opening, respectively
206 Limit/border of the opening
207a-207d Variants of the first closure
207′ Punctured first closure
208 First opening section of the opening
209 Second opening section of the opening
210 Point for the creation of an access into the housing interior
211 Polymer coating
212 Access into the housing interior
213 Polymer coating
214 Puncturing tool
215₁, 215₂ Indentations in the internal region of the first closure
216 Second closure
217 Edge region of the first closure
240 Hermetically closed battery
241 Battery housing
300 Closed battery
301 Battery housing
302, 303 Electrodes having different polarities
304 Wall of the housing
305 Point for the creation of an access into the housing interior (screw closure)

### 306 Screw cap

307 Collar of opening
308 Access into the housing interior

1.-16. (canceled)

17. A battery for storing electrical energy on an electrochemical basis, the battery comprising:
a housing sealed hermetically and comprising a hardcase; and
at least one electrochemical cell contained within the housing and comprising an organic electrolyte;
wherein a point in a wall of the housing is provided for creation of an access to a housing interior,
wherein the point for the creation of the access to the housing interior is configured to create the access to the housing interior and to hermetically close again the access created to the housing interior; and
wherein the access to the housing interior is configured in an opened state to vent the electrochemical cell.

18. The battery according to claim 17, wherein the access to the housing interior is further configured in the opened state for filling the electrochemical cell with additional electrolyte.

19. The battery according to claim 17, wherein the point for the creation of the access to the housing interior comprises an opening in the wall of the housing, the opening being sealed hermetically with a closure and further being configured to create the access to the housing interior by puncturing of the closure.

20. The battery according to claim 19, wherein an opening cross section of the opening in the wall of the housing widens continuously or incrementally from a housing interior outward;
wherein the opening comprises at least two opening sections having different-sized opening cross sections; and
wherein the closure is recessed relative to a housing-outside end of the opening.

21. The battery according to claim 19, wherein a limit of the opening formed in the wall of the housing is staircase-shaped or conical.

22. The battery according to claim 19, wherein the closure is disposed in an opening section of the opening having a shape substantially matching a shape of an external edge of the closure, and
wherein the external edge of the closure is joined hermetically to a surrounding housing wall.

23. The battery according to claim 19, wherein the closure is embodied as one of the following:
a planar disk or plate;
a planar disk or plate whose surface side facing the housing interior is covered with a polymer layer;
a disk or plate which, at least on one surface side of the closure, in an internal region, comprises an indentation;
a disk or plate which, at least on one surface side of the closure, in an internal region, comprises an indentation, and the indentation facing the housing interior is covered with a polymer layer.

24. The battery according to claim 17, wherein the point for the creation of the access to the housing interior comprises a screw closure, the screw closure being configured to create the access to the housing interior by unscrewing of a screw cap and to close again the access to the housing interior by screwing of the screw cap.

25. A method for operating a battery having a housing which is sealed hermetically and embodied as a hardcase and in which at least one electrochemical cell based on an organic electrolyte is contained, the method comprising:
opening the housing at a point thereon configured for creation of an access to the housing interior, so as to vent the at least one electrochemical cell; and
hermetically reclosing the access to the housing interior resulting from the opening of the housing.

26. The method according to claim 25, further comprising:
introducing additional electrolyte through the access to the housing interior resulting from the opening of the housing so as to fill up the cell with the additional electrolyte.

27. The method according to claim 25, wherein the housing is opened at the point thereon configured for the creation of the access to the housing interior by puncturing a first closure previously closing the access.

28. The method according to claim 27, wherein the point for the creation of the access to the housing interior is embodied before being opened as a hermetically sealed opening in a wall of the housing, a cross section of the hermetically sealed opening widening continuously or incrementally from the housing interior outward;
wherein the hermetically sealed opening is sealed hermetically by the first closure;
wherein the first closure is recessed relative to a housing-outside end of the access; and
wherein the access is hermetically reclosed by placement of a second closure means into an opening above the recessed first closure.

29. The method according to claim 28, wherein the second closure is placed into an opening section of the opening, the opening section having a shape substantially matching a shape of an external edge of the second closure , and
wherein the external edge of the second closure is joined hermetically to a surrounding housing.

30. The method according to claim 27, wherein the puncturing takes place using a puncturing tool having a tubular part, and
wherein the additional electrolyte is introduced using the tubular part of the puncturing tool.

31. The method according to claim 25, wherein the point for the creation of the access to the housing interior comprises a screw closure,
wherein the housing is opened by opening of the screw closure, and the housing is hermetically closed by the closing of the screw closure.

32. The method according to claim 25,
wherein the additional electrolyte is a same type as the electrolyte contained in the cell;
wherein the additional electrolyte comprises one or more additives configured to extend a lifetime of the cell and/or to attenuate or inhibit secondary reactions of the electrolyte with electrodes of the electrochemical cell; and/or
wherein the additional electrolyte comprises lithium-containing salts for providing additional electrochemically active lithium in a cell cycle following the introduction of the additional electrolyte.
